(19) United States
(12) Patent Application Publication
(10) Pub. No.: US 2025/0021601 A1
(43) Pub. Date: Jan. 16, 2025

(54) Method and System for the Asynchronous, Scalable Review of Video Responses to Video Scripts Utilizing Peer Evaluation

(71) Applicant: CollegeNET, Inc., Portland, OR (US)

(72) Inventors: James H. Wolfston, JR., Portland, OR (US); Mayur Palankar, Portland, OR (US); Herts Chen, Portland, OR (US); Zac Evanchak, Portland, OR (US)

(21) Appl. No.: 18/773,165

(22) Filed: Jul. 15, 2024

Related U.S. Application Data
(60) Provisional application No. 63/526,900, filed on Jul. 14, 2023.

(51) Int. Cl. G06F 16/738

(52) U.S. Cl. CPC G06F 16/738

(57) ABSTRACT

A method and system are described for asynchronous peer or proxy review of video-based responses. A database is provided that includes pointers to video-based speaking prompts, video-based responses associated with the prompts, and scores associated with the responses. A plurality of user participants record responses that are scored by other user participants or proxy scorers, and recorded response scripts are dynamically assigned to a plurality of scorers for scoring such that assignments are distributed to scorers participating in a common event having an event time window. A server is in communication with the database and further in communication with client devices for user participants or proxies. The server provides a web-based graphical user interface enabling user participants to playback prompts and record responses thereto within a response time window and scorers to determine scores for response scripts assigned by the assignments module to the scorer.

### CROSS REFERENCE TO RELATED APPLICATION

This application claims the benefit of U.S. Provisional Application No. 63/526,900, filed Jul. 14, 2023. The foregoing related application, in its entirety, is incorporated herein by reference.

### TECHNICAL FIELD

The following disclosure relates to asynchronous methods and systems for creating video scripts and providing scalable review of participant video responses via peer review and scoring.

### BACKGROUND

There are many scenarios where organizations such as a corporate or academic institutions are tasked with asking questions and assigning scores or otherwise evaluating participant responses according to the quality of their ideas, demeanor, persuasiveness, or other subjective factors. Such scenarios include admissions interviewing, job interviews, marketing focus groups, collecting feedback, or coordinating information sharing or brainstorming amongst customers. As examples, interviews might be for job openings, admission to a school or university, acceptance into a society or professional organization, or for various other purposes. When interviews are conducted, the interviewers typically need to make decisions about which candidates provided the best responses. Ordinarily, such evaluations are handled by scheduling real-time interviews which are later scored and assessed by personnel within the organization. The constraints and problems of scheduling and the constraints of follow-on scoring place practical limits on scalability.

In an academic setting, interviews are typically handled by an admissions office, which may include a dean of admissions and admissions counselors, perhaps with input from faculty or alumni. For employment-related opportunities, interviews may be held by a recruiting committee, a human resources department, and/or the supervisor(s) for open position(s). As these personnel try to perform interview assessments in a fair way, there are inherent limitations on consistency.

As a first matter, there may be scheduling complexities associated with conventional interviews. Typically, interviews are conducted live whether in-person, via video teleconference, or via phone call. However, applicants might have limited availability for interviews during normal work hours when, for example, they might be attending school or are working in a job. Also, if an applicant needs to interview with multiple people, it might be difficult to coordinate timeslots during a day when those people are available to conduct live interviews of an applicant.

Second, an applicant's responses during a live interview might provide an inaccurate representation of that applicant's talents and capabilities. Understandably, applicants may be nervous for interviews which can impact the quality of their responses. It is well-known that some people interview well, but later don't perform well on the job. This may be due to the fact that live interviews tend to measure an applicant's ability to provide instant, facile responses to questions. By contrast, other highly-qualified applicants who could perform better on the job might reveal more insightful and impressive answers if they are given more time to think through the issues raised by a question.

Another problem with conventional live interviews is that the interviewer is usually the only person evaluating how the interviewee performed. The interviewer can become overwhelmed by the number of interviews to conduct, and also, the interviewer represents only one perspective for evaluating the interviewees' responses. Put another way, even if an interviewee's responses might be deemed insightful in the abstract if scored by a broader set of reviewers, it is possible that on a given day those same responses might not resonate with a single interviewer.

For these and many other reasons, there are several problems and limitations inherent with conventional live interviewing.

### SUMMARY OF THE DISCLOSURE

A system is described for asynchronous peer or proxy review of video-based responses. A database is provided that includes pointers to video-based speaking prompts, video-based responses associated with the prompts, and scores associated with the responses. A plurality of user participants record responses that are scored by other user participants or proxy scorers, and recorded response scripts are dynamically assigned to a plurality of scorers for scoring such that assignments are distributed to scorers participating in a common event having an event time window. A server is in communication with the database and further in communication with client devices for user participants or proxies. The server provides a web-based graphical user interface enabling user participants to playback prompts and record responses thereto within a response time window and scorers to determine scores for response scripts assigned by the assignments module to the scorer.

A method is described for asynchronous peer or proxy review of video-based responses. A media file of a video-based speaking prompt is received. The speaking prompt is associated with an event and, via graphical user interface, the media file is provided to a plurality of user participants that are participating in the event and are tasked with recording a video-based response associated with the speaking prompt. A recorded response received from a user participant is dynamically assigned for review to a plurality of scorers comprised of user participants, proxy scorers, or a combination thereof, such that assignments are distributed, via a graphical user interface, to scorers participating in a common event having an event time window. Scores are received from the plurality of scorers indicating evaluations of the recorded response. In a plurality of database tables, the received scores are associated with the recorded response, the user participant that created the response, and the scorers that provided the respective evaluations.

### BRIEF DESCRIPTION OF THE DRAWINGS

FIG. 1 is a flow diagram for creating an asynchronous interview event, in accordance with embodiments of the disclosure.

FIG. 2 is a flow diagram for enrolling in events, creating interviewee responses, and evaluating other interviewees' responses, according to embodiments of the disclosure.

FIG. 3 is database schema according to embodiments of the disclosure.

FIG. 4 is a mapping of the relationships between events, scripts, video prompts, responses, and reviews, according to embodiments of the disclosure.

FIG. 5 illustrates an assignment process by which user participants are assigned to perform reviews/evaluations, according to embodiments of the disclosure.

FIG. 6 illustrates an assignment process by which user participants can be assigned different numbers of reviews/evaluations to perform, according to embodiments of the disclosure.

FIG. 7 illustrates an assignment process by which user participants' assignments are redistributed as the number of user participants changes, according to embodiments of the disclosure.

FIG. 8 is a screenshot of an example display in a graphical user interface for creating a script where there are video prompts available and both are required for inclusion in the script, according to embodiments of the disclosure.

FIG. 9 is a screenshot illustrating an example graphical user interface for configuring a round of an event, according to embodiments of the present disclosure.

FIG. 10 is a screenshot of an example graphical user interface for configuring an event, according to embodiments of the present disclosure.

FIG. 11 is a screenshot of an example graphical user interface for a user, who is an interviewee, to create responses to video prompts.

FIG. 12 is a screenshot of an example graphical user interface for a user to perform scoring of peer responses, according to embodiments of the present disclosure.

FIG. 13 is an additional screenshot of the example graphical user interface of FIG. 12, according to embodiments of the present disclosure.

FIG. 14 is a screenshot of an example graphical user interface displaying ranking of results from an event based upon scored responses, according to embodiments of the present disclosure.

FIG. 15 is a screenshot of an example graphical user interface displaying metrics associated with a participant's responses in an event, according to embodiments of the present disclosure.

### DETAILED DESCRIPTION

In accordance with various embodiments, the present disclosure is directed to online, video-based peer review system in which applicants participate in the process of evaluating other applicants. The interviewing system includes a database, a server, and a graphical user interface that enables applicants to be interviewed online through video recordings, while also conducting evaluations of video recorded answers of other participants.

The graphical user interface associated with the present disclosure can be considered a “focus ring” because it enables applicants to focus on their own performance and others' performances as well. By having applicants review each other, this frees up time so that more interviews can be conducted with fewer employees or members of an admissions committee. Additionally, the process allows interviewees to better understand how they are perceived, and also helps them improve their interviewing skill as they watch others while conducting their own reviews. Because the organization receives information about how the applicants are scoring each other, it achieves another insight into how applicants perceive their peers. Thus, the manner in which they score others can be become another relevant insight point for the organization.

In some embodiments, the focus ring interface provides a prompt or set of prompts in a first window and a participant's response(s) in another window. Each participant watches (and/or reads) the prompt(s) and then records a video response to the prompt(s) (within a certain time frame). Once the video responses of a participant are submitted by that participant, that response script is assigned for review by a set of other applicants or proxy reviewers. The participants each evaluate their assigned video interview response scripts and then submit their scores to the system.

In some embodiments, the graphical user interface can be customized by the sponsoring organization. The organization may specify the criteria by which participants are to score each other's interview responses—e.g. clarity of speech, friendliness, confidence, etc. The number of criteria and how it is to be scored can vary by implementation, but the same information is conveyed to each of the applicants for their scoring. The applicants' evaluations are then tabulated and used to generate assessments of each applicant's response script. Additionally, each applicant's set of evaluations can be tabulated to generate an additional assessment regarding that applicant's capability to render fair assessments of his or her peers.

In some embodiments, the system is configured such that participation in the focus ring requires that all participants perform reviews of the same number of other participants. Put another way, if Candidate A's interview response script is being reviewed by six (6) peers, then Candidate A is also assigned six (6) video interview response scripts for review.

Also in some embodiments, proxies are assigned to participate as reviewers. A proxy is someone who evaluates participant responses but is not themselves answering the prompts or being evaluated. For example, proxies can include admissions directors (for academic admissions), human resources professionals (for employee interviews), alumni, etc. In some embodiments, a proxy is assigned randomly to only some—perhaps a small fraction—of the participants and that proxy's scoring of video interviews is then compared with the scoring done by the participants themselves. Such comparison can then be used to benchmark the fairness of the participants' evaluations.

In some embodiments, the graphical user interface provides the capability for participants to assess their peers over a set of rounds. Each round can have a response phase (where the participants record their responses) and a review phase (where the participants then perform their evaluations of others' response scripts). For example, an applicant can be tasked with evaluating peers using 1-10 scales, based on attributes determined by the organizer. Attributes might include subjective characteristics such as charisma, confidence, sincerity, coherence, organization, persuasiveness, etc.

After a focus ring event, applicants may receive a visualization of their performance, indicating how they were perceived and scored.

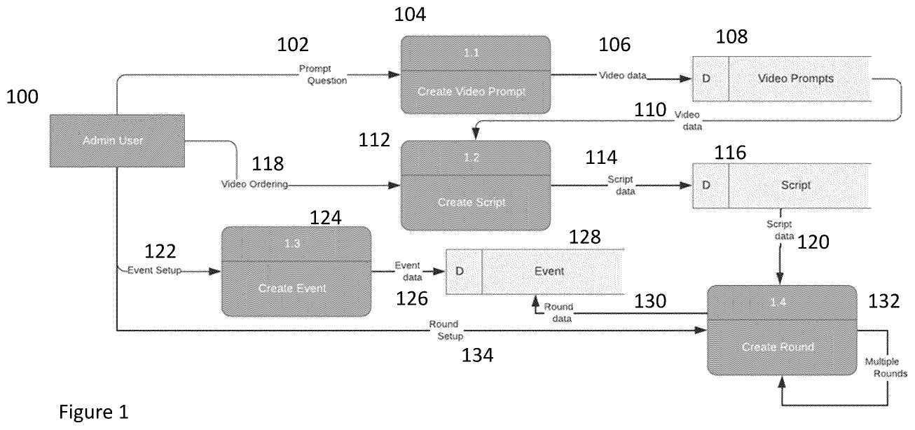

FIG. 1 is a flow diagram illustrating steps by which an administrative user can create an asynchronous interview event, in accordance with embodiments of the disclosure. Admin user 100 can create, develop, solicit, or select an interview prompt question 102, which will then be recorded 104 as a video file. Additionally or alternatively, the video prompt can be just audio or text. A video prompt can be a short question or topic, or it can ask about a complex issue. The prompt can be recorded by anyone in admin user's 100 organization, or it could be recorded by someone from outside the organization. Additionally, the video prompt can include an associated image, graphic, Powerpoint slide, or other exhibit in order to provide additional information or context that the interviewee can use for formulating a response. The video prompt, which can be in mp4 format or any other format(s), is stored in database 108.

The admin user 100 can order a set of videos 118 to create a script 112, using the video data 110 from the database of video prompts 108. A script can be a set of video prompts to be presented to participant(s) for soliciting responses. The script can be an indicator or identifier of the video prompts 108 to be included. This information, or script data 114, can be stored in script database 116.

The admin user 100 also can set up an event 112 by selecting scripts and rounds. By creating an event 124, the admin user generates event data 126, which is stored in event database 128. The event data includes round data 130, which indicates the relationship between the script data 120 and rounds. In 132, the admin user creates a round by indicating which scripts to use. The admin user 100 also determines how many rounds 132 of interviews there will be as part of the round setup 134. Each round can have different evaluation criteria, and be configured such that fewer interviewees are selected to move into the next round.

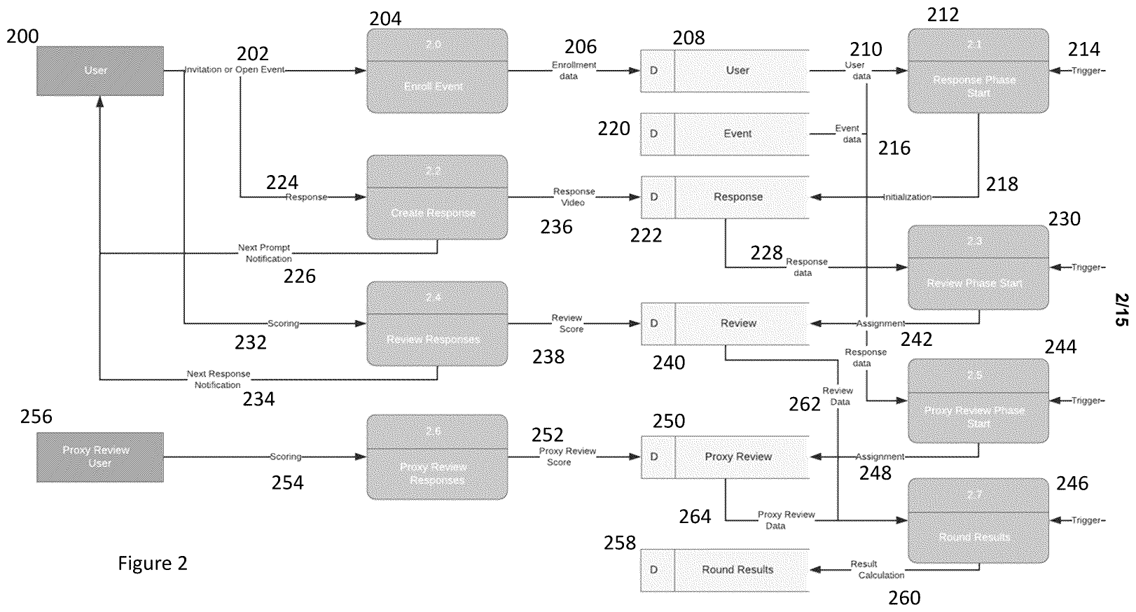

FIG. 2 is a flow diagram illustrating steps by which a participant can enroll in events, create responses, and evaluate others' responses. In FIG. 2, there are two types of users, an “interviewee user” 200, who is interviewed and evaluates interviews, and a proxy review user 256, who evaluates interviews but is not interviewed. User 200 can participate in an interview event either by being invited or by becoming aware of an event and electing to join it 202. Either way, the user 200 enrolls in the event 204 by providing user information, such as the user's name, contact information, and perhaps an identification of the job to be interviewed for, and such enrollment data 206 can be stored in user information database 208. The user data 210 from the database 208 can then be used for creating interview responses 212 and defining the participants in events 216. Particularly, in response to receiving a trigger 214, such as an indication that a video prompt is available, a user phase start 212 commences, which initializes 218 a response database 222 to store video responses to interview prompts. In that regard, the user 200 can elect to create a response 224 by recording a video 236 to be stored in the response database 222. The video 236 to be recorded can be in an mp4 format, for example, and/or can include text or other media formats. After creating a response 224, the user is prompted 226 to create a response to another video prompt.

Once a response is created and stored in response database 222, the response data 228 is utilized for starting the review/evaluation phase 230. The review/evaluation phase 230 determines assignments 242 for other users to perform evaluations of the recorded responses. The user 200 reviews another user's recorded response by submitting scores 232, and the review score information and other evaluation information is stored in a review database 240, according to the corresponding assignment information 242. After the user 200 prepares an evaluation of another response, the user 200 is prompted at 234 to submit an evaluation for another response to a video prompt that has been assigned to the user 200.

In addition to storing reviews by users 200, there are also proxy review users 256 who generate reviews to be stored as well. Once triggered in 244, the proxy review phase start occurs using a user's interview prompt response data 228, and assignments are made 248 for performing proxy reviews. Just like a user 200, a proxy user can generate scoring 254 and that review score information 252 can be stored in a proxy review database 250, analogous to the review database 240.

Once the review data 262 and proxy review data 264 are formulated, they are used for determining round results in 246, which is calculated 260 and stored in round results database 258.

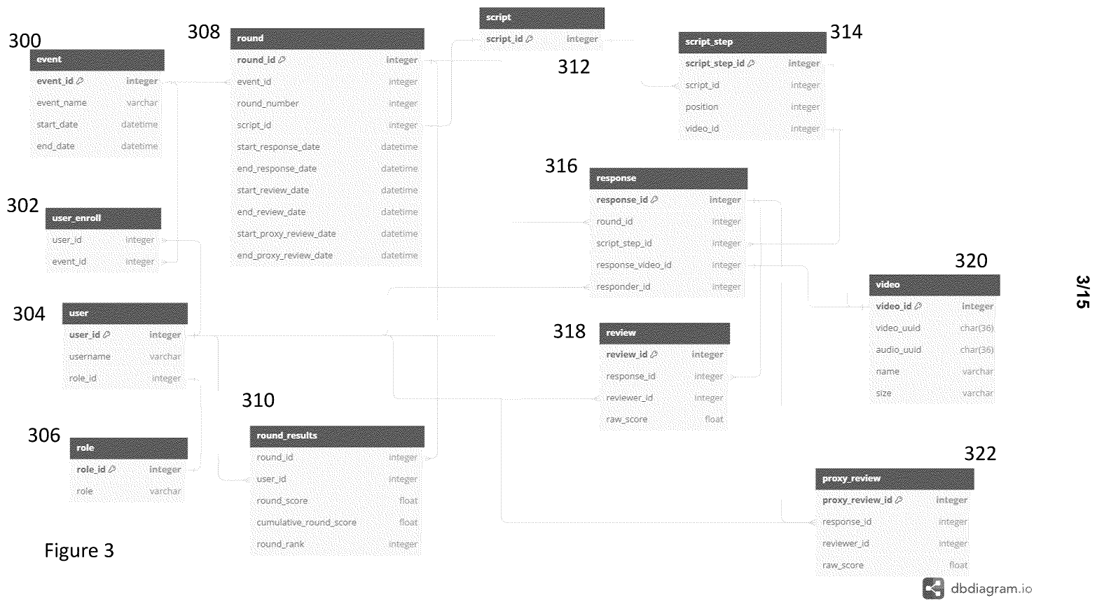

FIG. 3 illustrates a collection of interconnected database tables by which the events, rounds, and scripts are created and populated with video prompts, video responses, and evaluations/results of the responses. As can be seen, an event table 300 has an event ID and name, and is associated with a start and end date/time. The event ID from the event table 300 links with the round table 308, which further includes a round ID, round number, script ID, and date/timing information for the round. In turn, the script ID is provided by a script table 312, which further includes to a script_step table 314. The script_step table 314 links to the video table 320, which tracks videos associated with the scripts, and also links to the response table 316, which tracks information pertaining to the generation of a user's response to a video prompt. The user who is generating the response is a responder, having a responder ID, which is linked to a user table 304 with the user ID. Via the user ID, the user table 304 is linked to a user_enroll table 302. Because a user responds to video prompts as an interviewee and also reviews/evaluates others' responses, the user has a dual-role, and this information is tracked in a role table 306, with an associated role ID. A user also can be a proxy reviewer, which is tracked using a proxy_review table 322, where the response ID links this table to the user table 304 through the user ID. The review activity is tracked using review table 318, which includes a review ID for the review activity, a reviewer ID which links to the user table 304, and raw score associated with the results of the review/evaluation performed. Finally, there is a round_results table 310, which links to the round table 308 to track the results of the round, including the users who participated in the round as tracked by user ID.

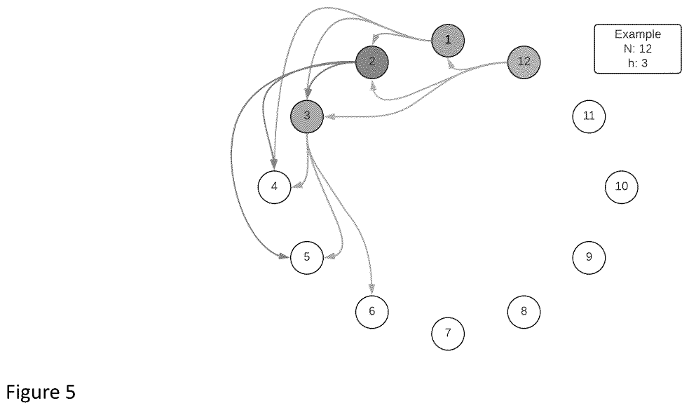

In a system, the database can be in communication with a server, which in turn communicates with client devices associated with the admin user, user participants, and proxy users. The server can be configured to provide Internet-based web access to the peer evaluation system. The server can run software by which assignments are made for users to perform reviews/evaluations of others' interviewee responses, as further described with reference to FIGS. 5-7. The server software also generates the graphical user interface for the client devices, and executes the peer evaluation system by which requests are provided for (i) video prompts from admin users, (ii) video responses by interviewees, and (iii) scores/evaluations from scorers, and by which the system receives, stores, and associates via the database (i) video prompts, (ii) video responses, and (iii) scores/evaluations from scorers.

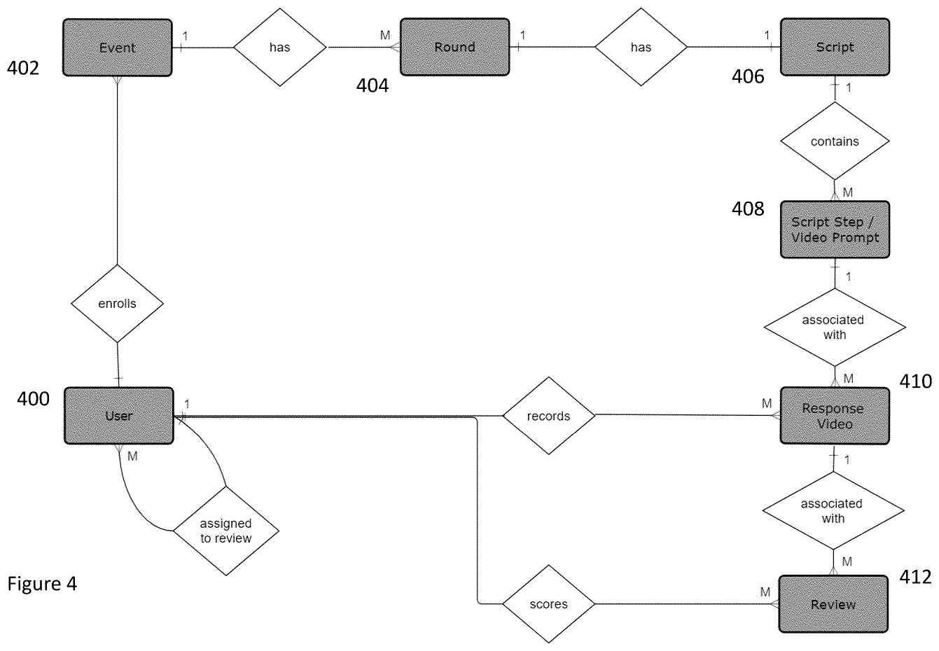

FIG. 4 provides an indication of the mapping of relationships between users and the performance of events, according to embodiments of the disclosure. As can be seen, a user 400 enrolls in one or more events 402, where each event 402 has one or more rounds 404. In turn, each round 404 has a script 406, which contains one or more video prompts 408. Each video prompt 408 is associated with at least one response video 410. Each response video 410 is associated with at least one (and preferably several) reviews/evaluations 412 by other users/proxy users 400. The users 400 record the response videos 410 and perform the scoring for the reviews 412 based upon the user assignments.

FIG. 5 illustrates an example process by which assignments are made for users to perform reviews/evaluations of other users' interviewee responses. FIG. 5 depicts twelve (12) users, 1-12. In this example, the assignment determination is made according to “N,” which is the number of users and “h,” the heat size. The objective is to assign “h” directed edges from each vertex without creating a loop between two vertices. This is done so that no one is reviewing/evaluating their own response. Put another way, there is no loop between two vertices. As depicted in FIG. 5, users 12, 1, 2, and 3 have recorded interviewee responses to video prompts. According to the assignment process, user 12's response is assigned to be reviewed/evaluated by users 1, 2, and 3. User 1's response is assigned to be reviewed/evaluated by users 2, 3, and 4. User 2's response is assigned to be reviewed/evaluated by users 3, 4, and 5. User 3's recorded response to the video prompt is to be assigned to be reviewed/evaluated by users 4, 5, and 6.

Through these assignments, users will review/evaluate several responses to video prompts recorded by their peers and provide scores, comments, or other feedback. The reviews/evaluations can assist the admin user that created the event and can also be instructive for those users who are performing the reviewing/evaluating, as it helps them to learn from their peers.

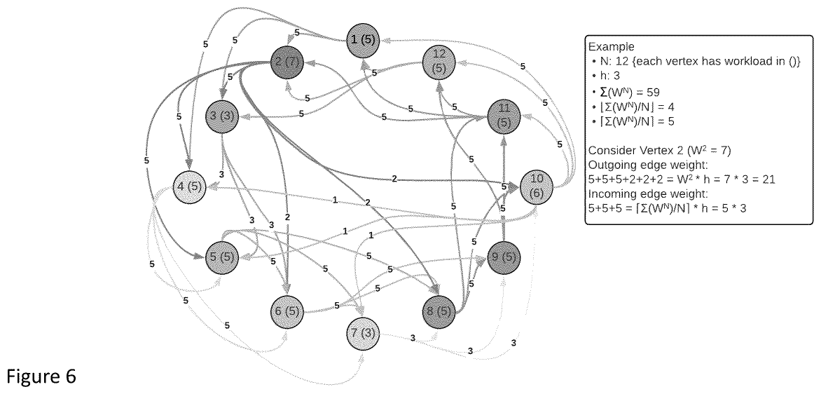

FIG. 6 illustrates an assignment process by which user participants can be assigned different numbers of reviews/evaluations to perform, according to embodiments of the disclosure. In FIG. 5, each user participant may submit the same number of responses to video prompts and those responses may be assigned the same number of reviewers/scorers. Further, each user participant can be dynamically assigned to review all of the responses from another user participant. In FIG. 6, it is assumed that, of the twelve (12) user participants, some submit more responses than other user participants, but all are assigned to review/score the same number of responses. This is accomplished by assigning some responses from a user participant to a first other user participant and some other responses to a second other user participant.

For example, for user 1, who submitted 5 responses, all 5 responses are assigned to be reviewed/evaluated by each of user 2, user 3, and also by user 4. Likewise, user 11 submitted 5 responses, and all 5 responses are assigned to be reviewed/evaluated by each of user 12, user 1 and also by user 2. But user 2 submitted 7 responses, and so 5 of that user's responses are to be reviewed by each of user 3, user 4, and user 5, but the remaining 2 of that user's responses are to be reviewed by each of user 6, user 8, and user 10. In this manner, each user participant will have all responses reviewed by 3 users, while each user participant will be tasked with reviewing/scoring the same number of responses, even though different user participants have submitted different numbers of responses.

Continuing with FIG. 6, there are N vertices (number of users) and associated workload for each user is W^{N}. The heat size is “h” and N>2h+1. The assignment is performed by assigning at least h directed edges from each vertex without creating a loop between two vertices. The weight is assigned to each directed edge (<=W^{N} for each head vertex) such that the sum of all weights of the directed edges from a vertex equals h*W^{N} of the vertex, the sum of all weights of the directed edges to a vertex should be between h*_{└}Σ(W^{N})/N_{┘} and h*^{┌}Σ(W^{N})/N^{┐}

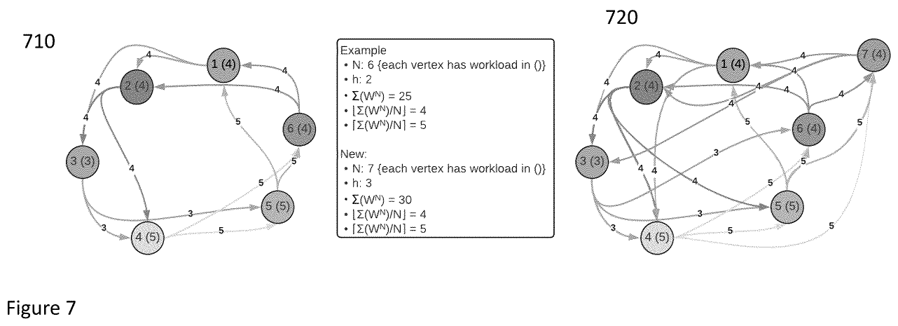

FIG. 7 illustrates an assignment process by which user participants' assignments are redistributed as the number of user participants changes, according to embodiments of the disclosure. In the ring in 710, there are 6 user participants who provided between 3 and 5 responses to be reviewed. Their responses are assigned to other user participants for review as per the technique described with reference to FIG. 6. In 720, an additional user participant, 7, is added to the event. This creates a shift in the assignments. Thus, in FIG. 7, given a graph with the conditions of FIG. 6, a new graph is output with N+1 vertices with the same constraints.

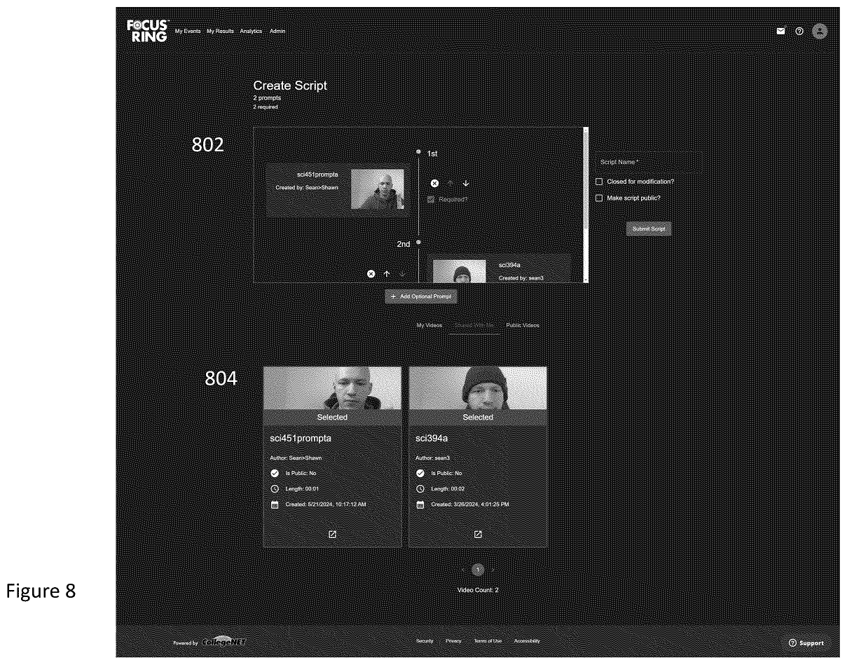

FIG. 8 is a screenshot that is an example display in a graphical user interface for creating a script where there are video prompts available and both are required for inclusion in the script. In this example, a display is provided at 804 for the two video prompts that are available for selection. For each video prompt, a freeze frame image of the person providing the prompt is included, along with other identifying information about the author of the prompt and the video file date and length. The admin user selects both video prompts to be included in the script. In section 802 of the graphical user interface, the video prompts are arranged in the desired order for the script. As can be seen, the admin user can select which prompt will be presented first and which one will be presented second.

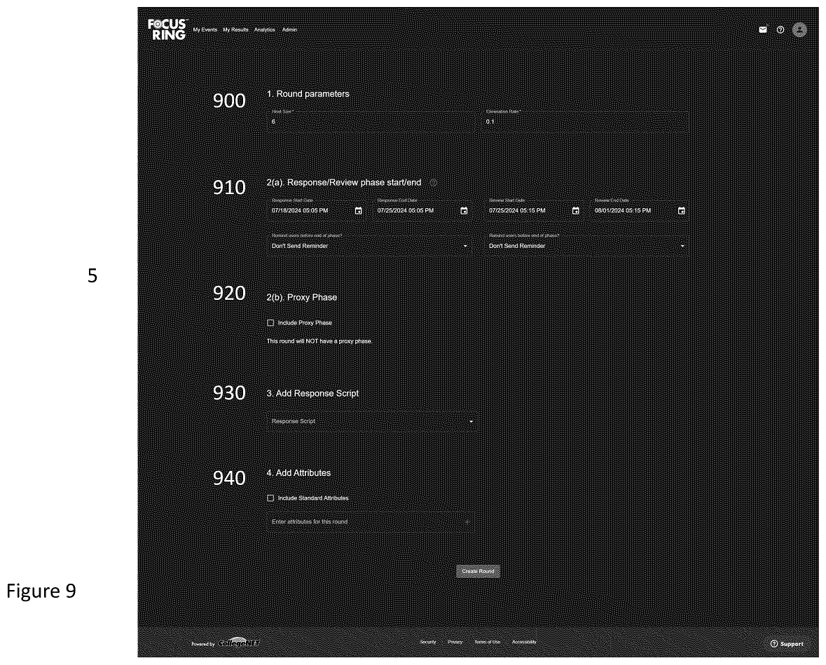

FIG. 9 is a screenshot illustrating an example graphical user interface for configuring a round of an event, according to embodiments of the present disclosure. At 900, the admin user selects the heat size and elimination rule. This indicates how many responses each user will be reviewing/evaluating, and how many will be eliminated from that heat at the conclusion of the round based on score amounts. At 910, the admin user selects the timeframe for the round, including the response start and end dates and the review start and end dates. At 920, the admin user selects whether to include any proxy users (who will review/evaluate but are not interviewees). At 930, the admin user adds the response script, selecting the video prompts to be included in the round. Finally, at 940, the admin user can add any attributes for the round.

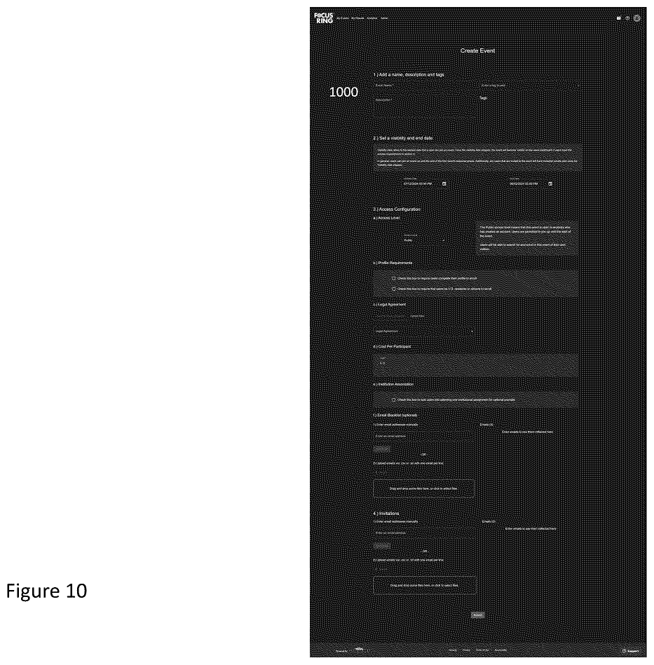

FIG. 10 is a screenshot of an example graphical user interface for configuring an event, according to embodiments of the present disclosure. In particular, at 1000, the admin user can identify the event by name, description, etc. The admin user can then set visibility and end dates, the access level, profile requirements, and other information to define the parameters of the event.

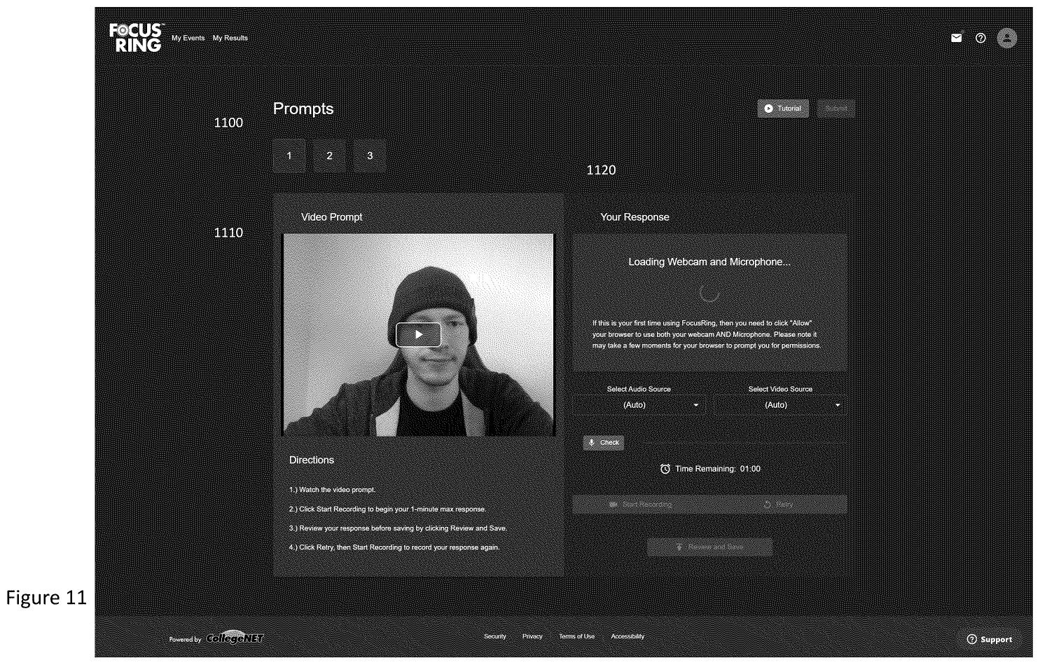

FIG. 11 is a screenshot of an example graphical user interface for a user, who is an interviewee, to create responses to video prompts. At 1100, the user can select from video prompts that have been created and included in a script for which this user is participating. The selected prompt (“1”) is shown in the window 1110. The user watches the video prompt and records a response at 1120. The graphical user interface is configured to utilize the integrated camera, microphone, and media player associated with the operating system for the user's computer, or if there are options, the user is prompted to select the audio source and video source. While the user is recording the response, a timer is used to provide a maximum time for the recording. The user can view draft recordings and decide whether to keep the recording or discard and try again. In this manner, and unlike in a live interview, the user can invest whatever time is desired to present his/her best response for evaluation.

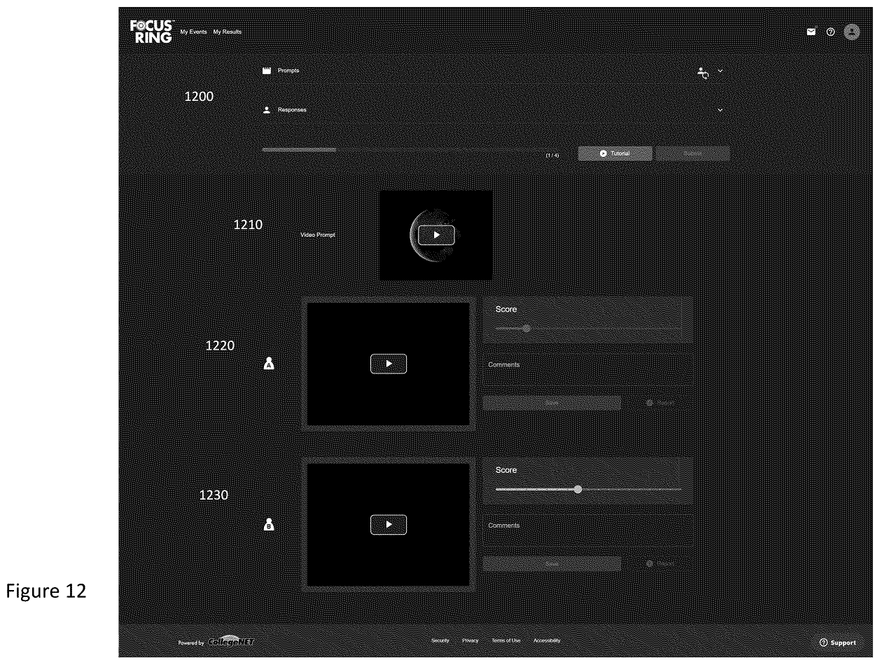

FIG. 12 is a screenshot of an example graphical user interface for a user to perform scoring of peer responses, according to embodiments of the present disclosure. As can be seen, in 1200, the user can watch a tutorial of the process. The user also can see an identification of the prompts and response for which the user is being assigned. At 1210, the user can re-watch the video prompt (which the user already had viewed when creating the user's own response). At 1220 and 1230, the user watches the interviewee response from another user and assigns a score. As can be seen, the user also has an opportunity to provide comments. Once the scores are provided, they are reported into the system.

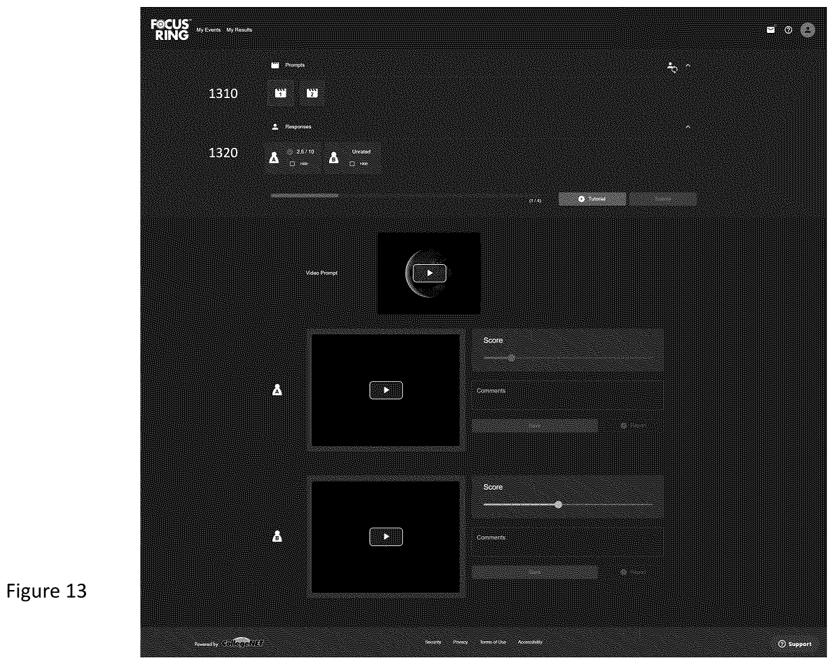

FIG. 13 is a screenshot continuing from FIG. 12, with selections between two prompts at 1310, and an indication of scores so far in 1320.

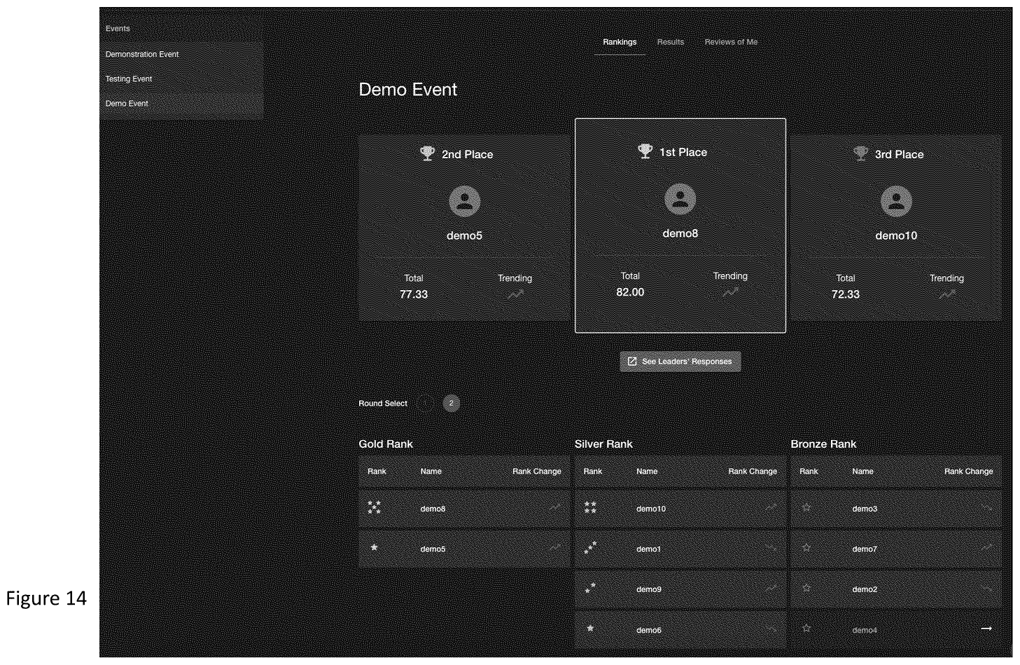

FIG. 14 is a screenshot of an example graphical user interface, according to embodiments of the disclosure, illustrating the results of an event, in which scores for all user participants are compared to determine a high score winner. As can be seen, this includes a “trending” indicator of how a user participant's rank is changing.

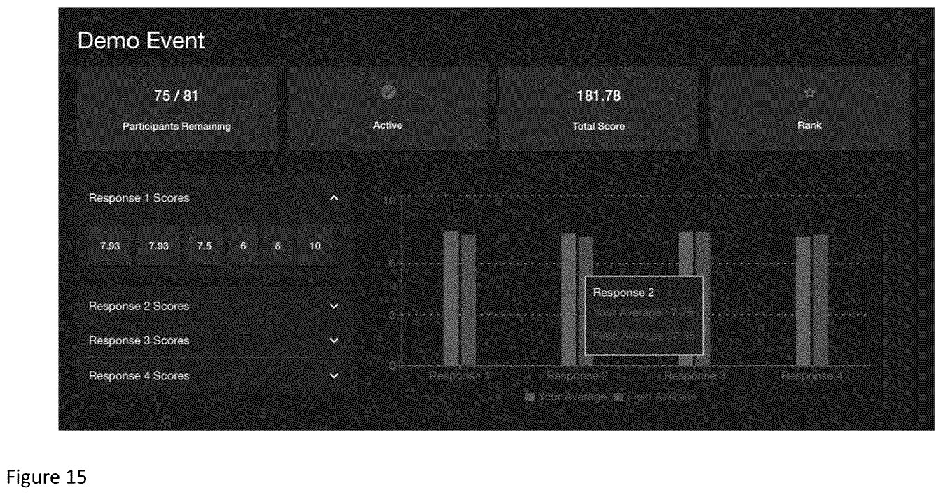

FIG. 15 is a screenshot of an example graphical user interface according to embodiments of the disclosure, in which a user's score is compared against an average so that a user can receive feedback regarding the result of the user participant's interview.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random-access memory associated with one or more physical processor cores.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results.

We claim:

1. A system for asynchronous peer or proxy review of video-based responses, comprising:
a database including pointers to:
(i) video-based speaking prompts,
(ii) video-based responses associated with the prompts, and
(iii) scores associated with the responses,
wherein a plurality of user participants record responses that are scored by other user participants or proxy scorers, and recorded response scripts are dynamically assigned to a plurality of scorers for scoring such that assignments are distributed to scorers participating in a common event having an event time window; and
a server in communication with the database and further in communication with client devices for user participants or proxies, wherein the server provides a web-based graphical user interface enabling:
(i) user participants to playback prompts and record responses thereto within a response time window, and
(ii) scorers to determine scores for response scripts assigned by the assignments module to the scorer.

2. The system according to claim 1, wherein scorers are assigned such that a user participant is not assigned to score that participant's own responses.

3. The system according to claim 1, wherein the number of response scripts assigned for scoring may vary by participant.

4. The system according to claim 3, wherein each user participant is tasked with scoring a minimum number of response scripts.

5. The system according to claim 3, wherein one or more proxies are assigned to score response scripts from user participants.

6. The system according to claim 1, wherein the event time window is associated with an event having a plurality of rounds, and based upon the scoring of a round, one or more of the user participants are eliminated from a next round, such that the next round begins with at least one fewer user participant.

7. The system according to claim 1, wherein each user participant in the event is assigned to score the same number of response scripts.

8. The system according to claim 1, wherein the scorers are dynamically reassigned as new participants enter an event within the event time window.

9. A method for asynchronous peer or proxy review of video-based responses, comprising:
configuring a database with pointers to:
(i) video-based speaking prompts,
(ii) video-based responses associated with the prompts, and
(iii) scores associated with the responses,
wherein a plurality of user participants record responses that are scored by other user participants or proxy scorers, and recorded response scripts are dynamically assigned to a plurality of scorers for scoring such that assignments are distributed to scorers participating in a common event having an event time window; and
communicating, via a server, with a client device for a user participant or proxy, wherein the server provides a web-based graphical user interface enabling:
(i) user participants to playback prompts and record responses thereto within a response time window, and
(ii) scorers to determine scores for response scripts assigned by the assignments module to the scorer.

10. The method according to claim 9, wherein scorers are assigned such that a user participant is not assigned to score that participant's own responses.

11. The method according to claim 9, wherein the number of response scripts assigned for scoring may vary by participant.

12. The method according to claim 9, wherein each user participant is tasked with scoring a minimum number of response scripts.

13. The method according to claim 9, wherein the event time window is associated with an event having a plurality of rounds, and based upon the scoring of a round, one or more of the user participants are eliminated from a next round, such that the next round begins with at least one fewer user participant.

14. The method according to claim 9, wherein each user participant in the event is assigned to score the same number of response scripts.

15. The method according to claim 9, wherein the scorers are dynamically reassigned as new participants enter an event within the event time window.

16. A method for asynchronous peer or proxy review of video-based responses, comprising:
receiving a media file of a video-based speaking prompt;
associating the speaking prompt with an event and providing, via graphical user interface, the media file to a plurality of user participants that are participating in the event and are tasked with recording a video-based response associated with the speaking prompt;
dynamically assigning a recorded response to a plurality of scorers comprised of user participants, proxy scorers, or a combination thereof, such that assignments are distributed, via a graphical user interface, to scorers participating in a common event having an event time window;
receiving scores from the plurality of scorers indicating evaluations of the recorded response; and
associating, in a plurality of database tables, the received scores with the recorded response, the user participant that created the response, and the scorers that provided the respective evaluations.

17. The method according to claim 16, wherein the number of response scripts assigned for scoring may vary by participant.

18. The method according to claim 16, wherein each user participant is tasked with scoring a minimum number of response scripts.

19. The method according to claim 16, wherein the event time window is associated with an event having a plurality of rounds, and based upon the scoring of a round, one or more of the user participants are eliminated from a next round, such that the next round begins with at least one fewer user participant.
